(19) United States
(12) Patent Application Publication
(10) Pub. No.: US 2022/0018154 A1
(43) Pub. Date: Jan. 20, 2022

(54) DUAL POSITION FOOT-OPERATED DOOR OPENER

(71) Applicant: Clarity Retail Services, LLC, Cincinnati, OH (US)

(72) Inventor: Lance Madden, Loveland, OH (US)

(73) Assignee: Clarity Retail Services, LLC, Cincinnati, OH (US)

(21) Appl. No.: 16/931,077

(22) Filed: Jul. 16, 2020

(51) Int. Cl. E05B 1/00; E05F 11/54

(52) U.S. Cl. CPC E05B 1/0015; E05Y 2900/132; E05F 11/54

(57) ABSTRACT

The present invention discloses a foot operated door opener adapted to allow a user to open a door without requiring the use of a hand. The opener comprises a foot support member extending from the base member. The base member configured to be attachable to a bottom surface of a door comprises a plurality of fastener apertures through which screws or similar attachment means may be passed to secure door opener to a door. The foot support member comprises a first portion extending horizontally from the base member, a first arc portion extends outwardly and diverges upwards from the first portion and a second arc portion extends outwardly and diverges downwards from the first portion. The foot support member is configured to be engaged by the user's foot and allows application of force to open the door.

### BACKGROUND

### 1. Technical Field

The present disclosure relates generally to a foot operated door opener, and more particularly, to a foot operated door opener adapted to allow a user to open a door without requiring the use of a hand.

### 2. Description of the Related Art

Door openers, for example, various latches, handles, grips, knobs, locks, and hooks are known in the art. The vast majority of these devices require the user to grasp the device with one or both hands and manipulate the device to open the door. Yet, occasions can and do arise in which a door needs to be opened without the use of the hand. For example, bathroom door handles can be a hotbed for germs due to the poor hygiene practices of others. In an effort to avoid contact with the door handle, restroom patrons often use any of the following methods: utilize their feet to pry the door open; use a paper towel to shield their hands from the door handle; grasp the door in a location other than the handle, or even wait for another patron to enter, in an effort to avoid contact with the door altogether.

Another example where one may require using their legs to open a door is when the handicapped, elderly or those weakened with illnesses that prevent them from using their hands and arms for opening a door with conventional doorknobs. Another such example where one may require using their legs to open a door is when a person is using both of their hands for carrying different things. More such examples include when the hands or arms are injured or when the hands are dirty or soiled or when the door is damaged, and so on.

There is, therefore, felt a need of device for allowing a user to open a door without having to touch the door with their hands.

### BRIEF SUMMARY

The present invention discloses a foot operated door opener adapted to allow a user to open a door without requiring the use of a hand. The opener comprises a foot support member extending from a base member. The base member configured to be attachable to a bottom surface of a door comprises a plurality of fastener apertures through which screws or similar attachment means may be passed to secure door opener to the door. The foot support member comprises a first portion extending horizontally from the base member, a first arc portion extends outwardly and diverges upwards from the first portion and a second arc portion extends outwardly and diverges downwards from the first portion.

In an embodiment, the first portion of the foot support member extends horizontally from a top end of the base member. The first arc portion extends outwardly from a distal edge of the first portion and diverges upwards from the first portion. The second arc portion extends outwardly from the distal edge of the first portion and diverges downwards from the first portion. Together, the first portion, the first arc portion and the second arc portion form a horizontal Y-shaped structure. The base member and the foot support member are a single, integral body. The body is made from one of following materials including, but not limited to, stainless steel, aluminum, copper, plastic, composite, and carbon fiber.

In one or more embodiments, the door opener further comprises one or more double-sided adhesive strips. Each adhesive strip comprises a first side and a second side. The first side of the strip is being attached to a rear surface of the base member, and the second side of the strip comprises a removable backing strip. In one or more embodiments, the one or more double-sided adhesive strips allow the door opener to be held in place on a door surface. In one or more embodiments, the one or more double-sided adhesive strips allow the door opener to be positioned and held in place until additional anchors are installed to more securely hold the opener in place.

In one or more embodiments, the door opener further comprises a foot support member extending from a base member configured such that the when the door opener is installed on a door surface, the bottom edge of the base member is aligned with the bottom edge of the door thereby placing the foot support member at the correct vertical height from the door bottom edge and floor surface for proper foot operation.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates a perspective view of a foot operated door opener, according to an embodiment of the present invention.

FIG. 2 exemplarily illustrates a rear perspective view of the foot operated door opener, according to an embodiment of the present invention.

FIG. 3 exemplarily illustrates a side view of the foot operated door opener, according to an embodiment of the present invention.

FIG. 4 exemplarily illustrates a side view of the foot operated door opener, according to another embodiment of the present invention.

FIG. 5 exemplarily illustrates a method of installation of the foot operated door opener, according to another embodiment of the present invention.

### DETAILED DESCRIPTION

According to aspects of the present disclosure, a dimensional force sensing hitch ball senses forces applied by a trailer to a tow vehicle in all directions in respect to a hitch. These force measurements are processed and displayed it in a number of possible ways such as trend plots, current measurements, and maximum measurements since a previous reset.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

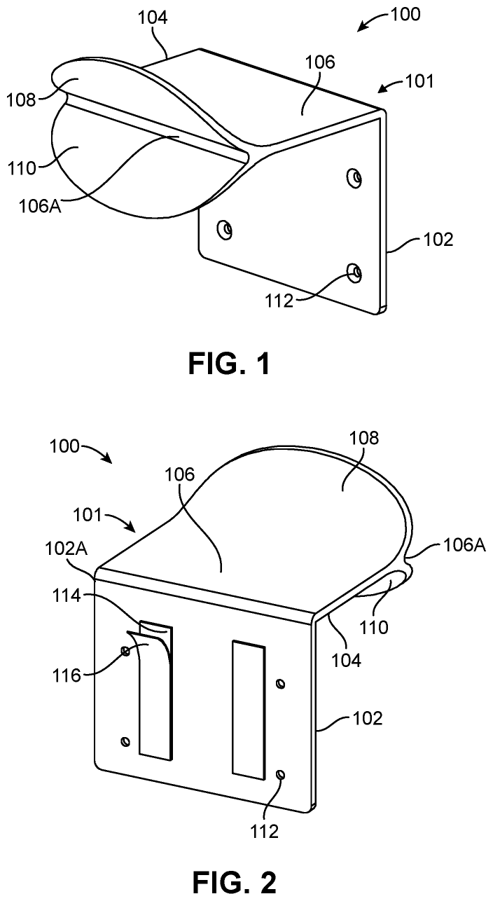

Referring to FIG. 1, the present invention discloses a foot operated door opener 100 adapted to allow a user to open a door without requiring the use of a hand. The opener 100 comprises a foot support member 104 extending from a base member 102. The foot support member 104 comprises a first portion 106 extending horizontally from the base member 102. The foot support member 104 further includes a first arc portion 108 that extends outwardly and diverges upwards from the first portion 106, and a second arc portion 110 that extends outwardly and diverges downwards from the first portion 106. The first arc portion 108 and the second arc portion 110 together form a structure similar to an opened duck-beak, which provides adequate surface area for receiving a user's foot for allowing the user to push open the door. The base member 102 is configured to be attachable adjacent a bottom edge of a door. The base member 102 comprises a plurality of fastener apertures 112 through which screws or similar fasteners may be passed to secure door opener 100 to the door. The base member 102 may be enlarged to form a kick plate for the door that is integrated into the foot operated door opener 100. Of course, the base member 102 can be configured in a wide variety of shapes to provide a desired coverage over the lower portion of the door.

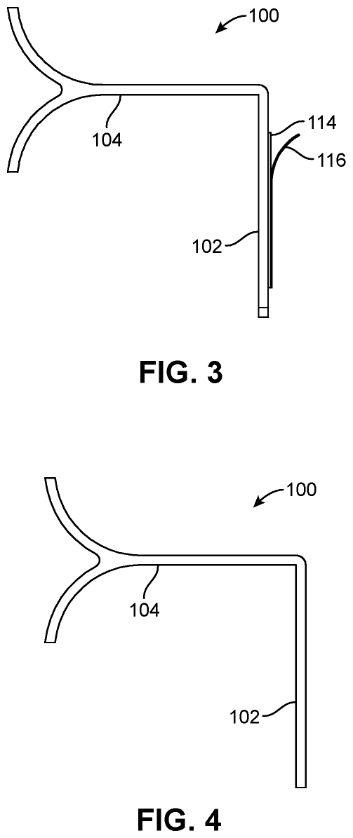

Referring to FIG. 2, the first portion 106 of the foot support member 104 extends horizontally from a top end 102A of the base member 102. The first arc portion 108 extends outwardly from a distal edge 106A of the first portion 106 and diverges upwards from the first portion 106. The second arc portion 110 extends outwardly from the distal edge 106A of the first portion 106 and diverges downwards from the first portion 106. Together, the first portion 106, the first arc portion 108 and the second arc portion 110 form a horizontal Y-shaped structure, as shown in FIG. 3.

In one embodiment, the foot support member 104 is configured to be engaged by a user's shoe at a top surface, a side surface, or a bottom surface of the support member 104 and allows application of force to open the door. In another embodiment, the first arc portion 108 is configured to be engaged by the user's shoe at a top surface, a side surface, or a bottom surface of the first arc portion 108 and allows application of force to open the door. In yet another embodiment, the second arc portion 110 is configured to be engaged by the user's shoe at a top surface, a side surface, or a bottom surface of the second arc portion 110 and allows application of force to open the door.

The base member 102 and the foot support member 104 are a single, integral structure that form a single integral body 101. In accordance with an embodiment of the present invention, the body 101 may be made from one of following materials including, but not limited to, stainless steel, aluminum, copper, plastic, composite material, carbon fiber or other sufficiently rigid material.

Referring to FIG. 2 and FIG. 3, the opener 100 further comprises one or more double-sided adhesive strips 114. Each adhesive strip 114 comprises a first side and a second side. The first side of the strip 114 is attached to a rear surface of the base member 102, and the second side of the strip 114 includes a removable backing strip 116. Another embodiment of the opener 100 is illustrated in FIG. 4, wherein the opener 100 is without adhesive strips 114.

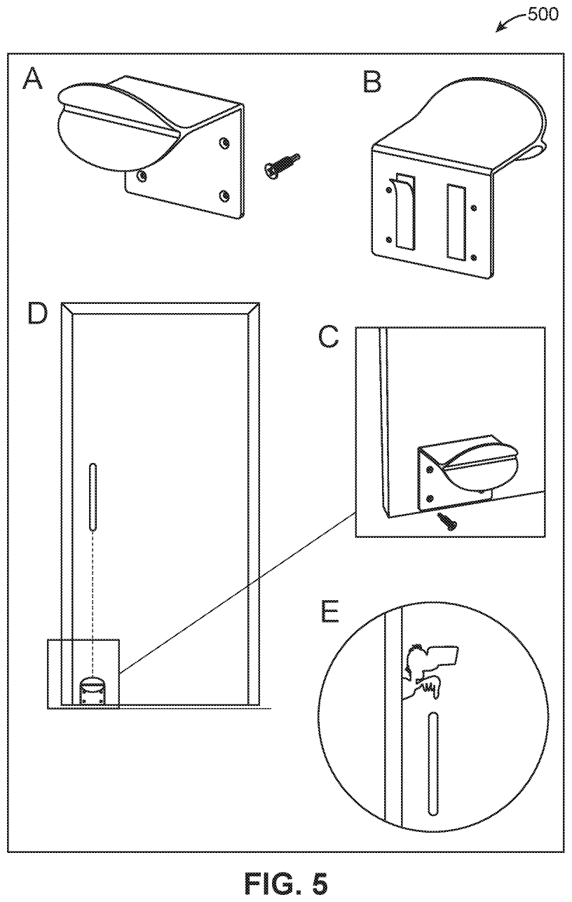

FIG. 5 exemplarily illustrates a method 500 of installation of the foot operated door opener 100, according to another embodiment of the present invention. At step A, a foot operated door retrieved from packaging before installation is shown. At step B, the backing strip 116 is removed from the one or more adhesive strips 114 attached to the rear surface of the base member 102. At step C, the door opener 100 is centered below the pull bar on the door with the bottom edge of the opener 100 aligned with the bottom edge of the door. The opener 100 is pressed against the door so that the adhesive strip 114 for attachment of opener 100 to the door. This attachment facilitates a temporary adhesion of the opener 100 to the door to allow a user to drill fastener apertures 112 into the door required for fastening the opener 100 to the door. Thereafter, screws or any other fastening device are passed through the fastener apertures 112 to secure door opener 100 to the door, at step D.

In one or more embodiments, the base member 102 and the foot support member 104 of the door opener 100 are configured having vertical dimensions such that the when the door opener 100 is installed, the bottom edge of the base member 102 is aligned with the bottom edge of the door thereby placing the foot support member 104 at the correct vertical height from the door edge for proper foot operation usage.

Further, a wide variety of fastening devices and configurations can be implemented to secure the door opener 100 to the door, including but not limited to, bolts, latches, hooks, interlocking plates, adhesives, and clamps. Optionally, at step E, a self-adhesive decal 118 is adhered to the door above the door opener 100, at the eye level. The self-adhesive decal 118 may include an indicia representing the presence of door opener 100 or usage procedure of the door opener 100. As shown in FIG. 5, the door opener 100 is secured to the door near the base or bottom edge of the door. The user may use a foot to engage the foot support member 104 and apply force on the door opener 100 to selectively pull or push on the bracket to thereby pull or push the door into an open position without use of the user's hands.

An advantageous aspect of the door opener 100, according to the embodiments described in the present disclosure, the door opener 100 enhances the sanitary nature of a standard foot-operated door opener 100 by enabling the user to use the bottom of the user's foot or shoe sole as the contact point with the door. Certain embodiments enable the user to use a top surface of the user's foot or foot covering as the contact point with the door. Another advantageous aspect of the door opener 100, in accordance with the embodiments of the present disclosure, is that the smooth design of the door opener 100 protects the user from injuries in cases where the user is wearing sandals or similar footwear wherein a portion of the foot is exposed to air.

In accordance with embodiments of the present disclosure, the foot-operated door opener 100 allows the user to initiate the opening of the door by using either the top of his foot or shoe, or by using the bottom of his foot or shoe sole. This feature that allows the user to use either the top or bottom of the shoe or foot ensures compatibility and function with open or closed toe shoes and persons who may have physical limitations or injury to their feet or lower body.

The door opener 100 facilitates easy opening of the door for a person whose hands are occupied with the carrying of bundles or the like. An exemplary application of the door opener 100 is in homes occupied by the elderly or those illnesses that prevent them from using their hands or arms for opening a door latched with conventional doorknobs. The door opener 100 is so designed and constructed such that it can be used to open a door that swings out or swings in because of its unique construction.

In various embodiments, the door opener 100 may be employed as a hands-free opener where a user is prohibited from using the user's hands to engage a door handle. For example, in a restaurant setting, a server, with trays in the server's hands, may use embodiments to open doors without putting the trays down. In other embodiments, the door opener 100 dimensions may be adjusted for a chosen door. In other embodiments, the door opener 100 utilizes a durable and slightly flexible material to provide opposing tension to the user's shoe or foot, which naturally aids in keeping the door opener in contact with the user's foot during operation.

While the disclosure has been described with reference to exemplary embodiments, it will be understood by those skilled in the art that various changes may be made, and equivalents may be substituted, for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A foot operated door opener, comprising:
a body having a base member and a foot support member,
wherein the base member is configured to be attachable to a door adjacent a bottom edge of the door;
wherein the foot support member comprises:
a first portion extending horizontally from the base member;
a first arc portion extends outwardly and diverges upwards from the first portion; and
a second arc portion extends outwardly and diverges downwards from the first portion, and
wherein the first portion, the first arc portion, and the second arc portion form a horizontal Y shaped structure.

2. The door opener according to claim 1, further comprises one or more double-sided adhesive strips, each adhesive strip comprises a first side and a second side, wherein the first side of the strip is attached to a rear surface of the base member, and the second side of the strip comprises a removable backing strip.

3. The door opener according to claim 1, wherein the body is made from one of stainless steel, aluminum, copper, plastic, composite, and carbon fiber.

4. The door opener according to claim 1, wherein the base member comprises a plurality of fastener apertures.

5. The door opener according to claim 1, wherein the foot support member is configured to be engaged by a user's shoe at a top surface, a side surface, or a bottom surface of the support member and allows application of force to open the door.

6. The door opener according to claim 1, wherein the foot support member is configured to be engaged by a user's foot at a top surface, a side surface, or a bottom surface of the foot support member and allows application of force to open the door.

7. A foot operated door opener, comprising:
a body having a base member and a foot support member;
wherein the base member is configured to be attachable to a door adjacent a bottom edge of the door;
wherein the foot support member comprises:
a first portion extending horizontally from the base member;
a first arc portion extends outwardly and diverges upwards from the first portion; and
a second arc portion extends outwardly and diverges downwards from the first portion;
wherein the first portion, the first arc portion and the second arc portion form a horizontal Y shaped structure; and
one or more double-sided adhesive strips, each adhesive strip comprises a first side and a second side, the first side of the strip is attached to a rear surface of the base member, and the second side of the strip comprises a removable backing strip.

8. The door opener according to claim 7, wherein the body is made from one of stainless steel, aluminum, copper, plastic, composite, and carbon fiber.

9. The door opener according to claim 7, wherein the base member comprises a plurality of fastener apertures.

10. The door opener according to claim 7, wherein the foot support member is configured to be engaged by a user's shoe at a top surface, a side surface, or a bottom surface of the foot support member and allows application of force to open the door.
